(19) United States
(12) Patent Application Publication
(10) Pub. No.: US 2007/0004864 A1
(43) Pub. Date: Jan. 4, 2007

(54) Method to enhance impact strength properties of melt processed polypropylene resins

(75) Inventors: Charles Beatty, Gainesville, FL (US); Nathan F. Tortorella, Sheboygan, WI (US)

Correspondence Address: AKERMAN SENTERFITT, P.O. BOX 3188, WEST PALM BEACH, FL, 33402-3188, US

(73) Assignee: University of Florida Research Foundation, Gainesville, FL (US)

(21) Appl. No.: 11/473,906

(22) Filed: Jun. 23, 2006

Related U.S. Application Data
(60) Provisional application No. 60/694,120, filed on Jun. 24, 2005.

(51) Int. Cl. C08L 23/04

(52) U.S. Cl. 525/240

(57) ABSTRACT

A polypropylene composition and a method to prepare the composition. The method includes the mixing and extrusion of an isotactic polypropylene, at least one impact modifying polymer, at least one primary co-agent that is a monofunctional monomer, at least one secondary co-agent which is a multifunctional monomer, oligomer, or polymer, and a radical initiator. The composition may be prepared in an extruder. The resulting composition has improved impact strength properties as compared to isotactic polypropylene and isotactic impact modifying polymer blends. The resulting composition may be used in a variety of forms such as extrusions, injection or blow-molded products, films, non-woven fabrics, or thermoformed products.

### CROSS-REFERENCE TO RELATED APPLICATIONS

This application claims benefit of U.S. Provisional Patent Application Ser. No. 60/694,120, entitled “METHOD TO ENHANCE IMPACT STRENGTH PROPERTIES OF MELT PROCESSED POLYPROPYLENE RESINS” filed on Jun. 24, 2005, the entirety of which is incorporated herein by reference.

### STATEMENT REGARDING FEDERALLY SPONSORED RESEARCH OR DEVELOPMENT

Not applicable.

### FIELD OF THE INVENTION

The invention relates to methods of modifying polypropylene homopolymer resins. More specifically, the present invention relates to methods of enhancing the impact strength properties of isotactic polypropylene resins.

### BACKGROUND OF THE INVENTION

Polypropylene materials, such as those formed by Ziegler-Natta or metallocene catalysts, are among the most versatile and commonly used thermoplastics in the world today. Polypropylene materials are useful in creating a great variety of finished goods including cast and blown films, injection molded parts, blow molded articles, thermoformed sheets, and fibers which may be subsequently spun or woven to create carpet and other finished goods. Most commercially available polypropylene is isotactic polypropylene, but atactic polypropylene has been available, and, more recently, syndiotactic polypropylene has been available.

Ziegler-Natta or metallocene catalysts allow a certain degree of control in regard to the polypropylene's tacticity. The difference in these tacticities is the arrangement of methyl groups extending from the carbon chain backbone of the finished polymer. A polypropylene molecule having primarily a random placement of the pendant methyl groups is known as atactic polypropylene. Conversely, a substantially regular polypropylene chain where the pendant methyl groups are primarily on the same side of the chain when the chain is aligned in an all trans conformation is known as isotactic polypropylene. This is the most widely manufactured form of polypropylene. Lastly, a substantially regular polypropylene chain where the pendant methyl groups primarily alternates from one side of the chain to the other when the chain is aligned in an all trans conformation is referred to as syndiotactic polypropylene. This form has only been produced from metallocene catalysts.

Polyethylene and isotactic polypropylene are the most widely produced types of polyolefins. Isotactic polypropylene tend to be stiffer and exhibit higher yield stresses and melting points in comparison with polyethylenes but are also more prone to fracture, especially at low temperatures and is particularly notch sensitive. This sensitivity to fracture is common to many polymers with higher glass transition temperatures. The fracture properties have been addressed to some degree by producing a toughened blend using rubber or other polymeric impact modifiers to improve low temperature impact resistance at some sacrifice in modulus.

There are a number of unique applications which are ideally suited to strong, flexible, and substantially clear polyolefins. For example, plasticized polyvinyl chloride (PVC) has traditionally been used either alone or with other polymer components to form a number of medical articles including bandages, surgical dressings, and intravenous (IV) solution bags. Plasticized PVC films possess many desirable properties including easy stretch, high degree of recovery, low fatigue and minimal permanent set. However, plasticized PVC film has become less desirable because of known or suspected carcinogens associated with both the PVC monomer and the various plasticizers used in its production. Clearly, in medical articles, food storage containers, and other applications where polymers are either in direct contact with blood or other bodily fluids or in contact with food or other items to be ingested or taken into the body, it would be desirable to replace materials like plasticized PVC film with various polyolefins, particularly those with very low extractable contents. However, as previously discussed, prior art isotactic polypropylenes either have too low an impact strength to be used in these areas, or the improved impact strength came with at least some sacrifice in modulus.

Improving the impact strength of isotactic polypropylene resins traditionally involve the addition of an elastomeric component, and producing a blend of an isotactic propylene polymer and an elastomeric component by compounding the two polymers. Such methods of improving the impact of isotactic polypropylene do not significantly contribute to increasing the melt strength of the resulting isotactic polypropylene impact copolymer or blend. Although both methods result in an isotactic polypropylene composition that displays some improvement of impact properties, these impact properties often show an imbalance between the notched impact tested parallel to the polymer injection flow direction of the injection molded test specimen, and the notched impact tested perpendicular to the polymer injection flow direction of the injection molded test specimen. Domain sizes of the two polymers can change upon subsequent processing. Hence it remains a goal to achieve an isotactic polypropylene composition where the impact strength is significantly enhanced relative to that of isotactic polypropylene without significantly sacrificing desirable properties of isotactic polypropylene such as the tensile strength and transparency in a manner that does not significantly increase the cost of manufacture by using readily available materials and well established processing methods.

### SUMMARY OF THE INVENTION

The present invention is directed to a method to prepare a polypropylene composition with enhancing impact strength properties were the provided components are isotactic polypropylene, at least one impact modifying polymer, at least one primary co-agent which is a monofunctional monomer, at least one secondary co-agent which is a multifunctional monomers, oligomers or polymers, and at least one radical initiator, where the components are mixed and extruded as the polypropylene composition. The impact modifying polymer is an elastomer, which is preferably a copolymer of ethylene and an alpha-olefin such as that from ethylene and 1-octene. The primary co-agent is a monovinyl monomer capable of undergoing vinyl addition by a radical. Appropriate secondary co-agents are multifunctional monomer contains two or more unsaturated groups capable of undergoing radical addition. Appropriate radical initiator include organoperoxides. Some or all of the components can be mixed prior to introduction to the extruder or mixed within the extruder by their addition at different sites of the extruder.

The invention is also directed to a polypropylene composition having a structure where an isotactic polypropylene has been combined with a dispersed impact modifying polymer by branches on said polymers and bridges between said polymers which are linked repeating units from at least one primary co-agent, which is a monofunctional monomers and at least one secondary co-agent, which is a di- or polyfunctional monomer, oligomer or polymer, and residuals of at least one radical initiator.

### DETAILED DESCRIPTION OF THE INVENTION

The present invention provides a method for preparing a polypropylene composition with enhanced impact strength by the of melt-processing an isotactic polypropylene and a impact modifying polymer, and a polypropylene composition made by this method. Isotactic polypropylene is a commercially beneficial polymer but has some properties that restrict its use from certain consumer products, such as bottles. Generally it is brittle at or below room temperature displaying a low impact strength in a notched impact test. The present invention provides a polypropylene composition that displays a substantially higher impact strength than that of isotactic polypropylene without significantly compromising the clarity or stress-strain performance.

Accordingly, the present invention provides a method of combining isotactic polypropylene with at least one impact modifying polymer, at least one primary co-agent comprising a monofunctional vinyl monomer, at least one secondary co-agent comprising a di- or polyfunctional monomer, oligomer, or polymer, and at least one radical initiator, which upon heating of the mixture in an extruder, radical initiation, propagation and termination steps result in a polypropylene composition with enhanced impact properties such that it may be used in applications normally considered impractical for isotactic polypropylene because of its insufficient impact strength. Not wishing to be bound by theory, it is believed that the process results in a radical initiated in-situ grafting of branches formed from the co-agents on the polypropylene and the impact modifying polymers. The co-agents also inhibit significant molecular weight degradation of the polymers while forming a “bridge” between the polymers. By carrying out the reactions in a high sheer environment, such as a reactive twin screw extruder the polymer domains are formed at a relatively small size favorable to improved impact strength where this domain structure is stabilized by the “bridges” formed by the co-agents sufficiently maintain these domains and the associated properties after subsequent heating and processing of the composition. In general, the small domain size also promotes transparency in the resulting composition.

Although the radical process resulting in a polypropylene composition will occur regardless of the polymer tacticity, isotactic polypropylene displays properties, such as tensile strength, that are desirable to maintain or only slightly degrade, that are not available with atactic or syndiotactic polypropylene and is used for the invention. The impact modifying polymer is an elastomer. Preferred impact modifying polymers are homogeneously branched linear and substantially linear ethylene copolymers with a density measured in accordance with ASTM D-792 of from about 0.85 to about 0.92 g/cm³, and a melt index or 12 measured in accordance with ASTM D-1238 (190° C./2.16 kg weight) of from about 0.01 to about 300. Characteristics that make these ethylene copolymers attractive for this application over other elastomers include: excellent heat aging and/or UV resistance; low temperature flexibility; clarity; ease of processability of the copolymer with isotactic polypropylene; and the availability of many grades with varying composition, density and molecular weight permitting one to optimize and balance the properties of the polypropylene composition to the application for which it is prepared. These polyolefin elastomers are copolymers of ethylene and another alpha-olefin such as butene or octene. The copolymer of ethylene and 1-octene available under the tradename ENGAGE® by DuPont Dow Elastomers is beneficial as an impact modifier polymer. However, it is to be understood that other polymers that provide one or more of these desirable characteristics may also be used in the present invention in lieu of a copolymer of ethylene and 1-octene.

Examples of other impact modifying polymers that may be used in the present invention include, but are not limited to, ethylene/α-olefin polymers, ethylene/propylene copolymers, ethylene/butylene copolymers, ethylene/octene copolymers, linear ultra low density polyethylene, homogeneously branched, linear ethylene/α-olefin copolymers, homogeneously branched substantially linear ethylene/α-olefin polymers, and various ethylene/propylene/diene modified co-, ter- and tetrapolymers. As used herein, “substantially linear” means that a polymer has a backbone substituted with from 0.01 to 3 long-chain branches per 1000 carbons in the backbone.

In addition to the isotactic polypropylene and the impact modifying polymer, at least one primary co-agent is included to promote and stabilized the interaction of polymers via bond forming radical processes. The primary co-agent is involved with the grafting on the impact modifier polymer and the polypropylene and can lead to branches on and “bridges” between the polymers. The primary co-agent can be any vinyl monomer that undergoes rapid radical polymerization and contains a single vinyl group. As used in regard to the primary co-agent a vinyl group is any carbon-carbon double bond that is capable of undergoing radical addition reactions. A preferred primary co-agent is styrene. Other co-agents can be α-methylstyrene, para-chlorstyrene, methyl acrylate, methyl methacrylate, ethyl acrylate, isopropyl methacrylate, n-hexyl acrylate, stearyl acrylate, vinyl acetate, or a vinyltriorganosilane. These monomers are incorporated as repeating units in branches and bridges on and between the polymers of the composition. They can be used in relatively large amounts to promote the radical reactions without the promotion of gelation.

The present invention also includes at least one secondary co-agent. The secondary co-agent is selected to enhance the effect of radical reactions between the primary co-agent and the polymers which can include but is not limited to participating in the graft reaction, providing chain transfer sites, and providing branching sites to affect the viscosity of the system during and after processing as desired. Suitable secondary co-agent are multifunctional monomers, oligomers or polymers that contain at least two unsaturated double bond per molecule that are capable of undergoing radical addition reactions. Suitable co-agents include divinyl benzene, 1,2 polybutadiene, triallylisocyanurate, diallyl terepthalate, allyl acrylate, glycerol diacrylate, glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis[1-(2acryloxy)]-p-ethoxyphenyldimethylmethane, bis[1-(3-acryloxy-2-hydroxy)]-p-propoxyphenyldimethylmethane, trishydroxyethyl-isocyanurate trimethacrylate; bisacrylates of polyethylene glycols of molecular weight 200-500, bis-methacrylates of polyethylene glycols of molecular weight 200-500, copolymerizable mixtures of acrylated monomers, and acrylated oligomers. Two preferred secondary co-agents are diethyleneglycol diacrylate (DEGDA) and trimethylolpropane triacrylate (TMPTA). Nevertheless, in general, any secondary co-agent may be used separately or in combination with other secondary co-agents that reacts readily with the one or more primary co-agents used and will reside as repeating units in the final isotactic polypropylene composition where at least one of the carbon-carbon double bonds has undergone radical addition. In the absence of a primary co-agent the secondary co-agents more readily lead to gelation.

The methods of the present invention requires the inclusion of at least one radical initiator to begin the cascade of abstraction, addition and exchange reactions that lead to grafting and “bridging” of the polymers with the co-agents. Preferred radical initiators have a decomposition half-life of less than 1 minute at the average process temperature during the formation of the polypropylene composition. Useful radical initiators include organoperoxides. Examples of organoperoxide initiators that may be used in the present invention include, but are not limited to, dialkyl peroxides, peroxy ketals, monoperoxycarbonates, diacyl peroxides, peroxyesters, and peroxydicarbonates. Suitable organoperoxides include those that contain α,α′-bis(t-butylperoxy)-diisopropylbenzene under the trade designation VULCUP™ and those that contain dicumyl peroxide under the trade designation DI-CUP™, which are available from Hercules, Inc. (Passaic, N.J.). Lupersol™ peroxides, including Lupersol™ 101 (2,5-dimethyl-2,5-di(t-butylperoxy)hexane), Lupersol™ 130 (2,5-dimethyl-2,5-di(t-butylperoxy)hexyne-3), and Lupersol™ 575 (t-amyl peroxy-2-ethylhexonate), made by Atofina, are also suitable for use in the method of the present invention. Other suitable organoproxides include di-t-butylperoxide, di-(t-amyl)butylperoxide, 2,5-di(t-amyl peroxy)-2,5-dimethylhexane, 2,5-di(t-butylperoxy)-2,5-diphenylhexane, bis(alpha-methylbenzyl)peroxide, benzoyl peroxide, t-butyl perbenzoate, 3,6,9-triethyl-3,6,9-trimethyl-1,4,7 triperoxonane and bis(t-butylperoxy)-diisopropylbenzene.

The identity and relative amounts of the isotactic polypropylene, the impact modifying polymers, the primary co-agents, the secondary co-agents, and the radical initiators, used to prepare the polypropylene composition may vary depending on one or more factors including, but not limited to, the selected properties of the final composition. In general, the isotactic polypropylene is provided at about 50 to about 99 percent by weight of the total polypropylene composition. Preferably, the isotactic polypropylene is provided at about 70 to about 90 percent by weight of the total polypropylene composition. The impact modifying polymer is provided at about 0.1 to about 50 percent by weight of the total polypropylene composition. Preferably, the impact modifying polymer is provided at about 3 to about 25 percent by weight of the total polypropylene composition. The primary co-agent or co-agents are provided in an amount of about 0.1 to about 12 percent by weight of the total polypropylene composition. Preferable the primary co-agent or co-agents are provided in an amount of about 4 to about 8 percent, by weight of the total polypropylene composition. The secondary co-agent or co-agents are provided in an amount of about 0.01 to about 4 percent by weight of the total polypropylene composition. Preferable the primary co-agent or co-agents are provided in an amount of about 0.4 to about 1.5 percent, by weight of the total polypropylene composition. The radical initiator or initiators are provided in an amount of about 0.01 to about 1 percent by weight of the total polypropylene composition. Preferable the radical initiator or initiators are provided in an amount of about 0.1 to about 0.4 percent, by weight of the total polypropylene composition.

The polypropylene compositions of this invention may be compounded with any one or more materials conventionally added to polymers. These materials include, for example, process oils, plasticizers, specialty additives including stabilizers, fillers (both reinforcing and non-reinforcing), and pigments. The polypropylene composition can be subsequently process in a more traditional manner by blending with isotactic polypropyene and/or an impact modifying polymer without the inclusion of additional radical initiators or any co-agents. These materials may be compounded with the polypropylene compositions of the present invention during the preparation or as a separate step after the polypropylene composition has been prepared.

Process oils can be used to reduce the viscosity, hardness, modulus and/or cost of the polypropylene composition. The process oils can be those classified as paraffinic, naphthenic or aromatic oils. The process oils can be used in an amount ranging from about 0.5 to about 50 percent by weight of the total compounded composition. Low to medium molecular weight ester plasticizers may also be used to enhance low temperature performance. Examples of esters which may be used include, but are not limited to, isooctyltallate, isooctyloleate, n-butyltallate, n-butyloleate, butoxyethyloleate, dioctylsebacate, dioctylazelate, diisooctyidodecanedioate, and alkylalkylether diester glutarate.

A variety of specialty additives can be included with the polypropylene compositions of the present invention. The additives may include surface tension modifiers, anti-block agents, lubricants, antimicrobial agents such as organometallics, isothtazolones, organosulfurs and mercaptans; antioxidants such as phenolics, secondary amines, phophites and thioesters; antistatic agents such as quaternary ammonium compounds, amines, and ethoxylated, propoxylated or glycerol compounds; fillers and reinforcing agents such as carbon black, glass, metal carbonates such as calcium carbonate, metal sulfates such as calcium sulfate, talc, clay or graphite fibers; hydrolytic stabilizers; lubricants such as fatty acids, fatty alcohols, esters, fatty amides, metallic stearates, paraffinic and microcrystalline waxes, silicones and orthophosphoric acid esters; mold release agents such as fine-particle or powdered solids, soaps, waxes, silicones, polyglycols and complex esters such as trimethylolpropane tristearate or pentaerythritol tetrastearate; pigments, dyes and colorants; plasticizers such as esters derived from dibasic acids with monohydroxy alcohols such as o-phthalates, adipates and benzoates; heat stabilizers such as organotin mercaptides, an octyl ester of thioglycolic acid and a barium or cadmium carboxylate; ultraviolet light stabilizers used as a hindered amine, an o-hydroxy-phenylbenzotriazole, a 2-hydroxy, 4-alkoxyenzophenone, a salicylate, a cynoacrylate, a nickel chelate and a benzylidene malonate and oxalanilide. Depending upon the type of additive, the quantity required to achieve the desired effect can differ significantly, as is common in the production of a plastic article. When used, even for those generally used in relatively large amounts, such as fillers, the amount of the additive typically does not exceed about 45 percent by weight based on total compounded composition, and can be beneficially added in a range of about 0.001 to about 20 percent by weight of the total compounded composition.

The method of the present invention forms the polypropylene composition of the present invention by mixing the components and processing them in the melt under sheer. The various components may be combined using any conventional means. These means includes, but is not limited to, imbibing the liquid components, which can include the radical initiators, co-agents, and certain additives, onto polymer pellets prior to compounding, adding these liquid components or solid components to polymer pellets as the pellets enter the compounding apparatus, such as in the throat of an extruder, adding the components to the melted polymers in a compounding apparatus, as a liquid, solid or dispersion at an appropriate port in the compounding apparatus. A preferred embodiment is to add the initiator, primary coagent and secondary coagent to the polymer pellets as the pellets enter the compounding apparatus. However, it should be understood that the manner, mode, and order of addition can vary to achieve the desired polypropylene composition with the desired properties and will be determined for the specific components and processing apparatus chosen to carry out the method.

In one embodiment, the compounding apparatus is a reactive twin-screw extruder. The process as carried out by twin screw reactive extrusion offers one or more advantages over other methods including, but not limited to, excellent mixing of materials, various ports for addition of materials or venting, a continuous extrusion process, and/or good heat transfer characteristics.

The extrusion process takes place at a temperature which ultimately exceed the melting point of the polypropylene composition. The temperature can vary through the different zones of the extruder as required. For example, in one embodiment using a twin-screw extruder, a temperature gradient can vary from about 150° C. in the feed zone to about 240° C. at the die. In another embodiment, the process temperatures of the twin-screw extruder may include a temperature gradient that varies from about 160° C. in the feed zone to about 220° C. at the die. Likewise the screw speed of the extruder may vary as needed. Typically, but not necessarily, the screw speed can be from about 100 rpm to about 250 rpm.

The polypropylene compositions of the present invention can be formulated and processed to result in a composition that retains the majority of its transparency and/or its tensile strength of isotactic polypropylene while significantly improving the impact strength, melt strength, and/or heat distortion temperature. The processability of the polypropylene composition relative to the isotactic polypropylene included is not compromised by the modification. Therefore, the polypropylene compositions of the present invention may be modified further allowing further downstream molding, extruding, casting, spinning or any other form of plastic article manufacture that occurs using traditional equipment. For example, a polypropylene composition can be prepared that is beneficial for molded bottles where the Notched Izod Impact Strength may be increased by about 300 to about 1400% or the failure drop height for a drop impact test of water filled blow molded bottles may increased by about 100 to about 350%.

The polypropylene compositions of the present invention have a wide variety of potential uses. For example, the compositions of this invention may be fabricated into parts, sheets or other form using any one of a number of conventional procedures for processing thermoplastic elastomers. The compositions may also be formed, spun or drawn into films, fibers, multi-layer laminates or extruded sheets, or can be compounded with one or more organic or inorganic substances, in any apparatus suitable for such purposes.

Reference will now be made to illustrative examples of the present invention. It is to be understood that these example are not to be considered to be limiting in any manner of the overall scope of the present invention.

### EXAMPLES

In the following examples various grades of isotactic polypropylene was used from various commercial suppliers. The impact modifying polymer was ENGAGE® by DuPont Dow Elastomers (Wilmington, Del.), a copolymer of ethylene and 1-octene. The radical initiator was 2,5-dimethyl-2,5-di-(t-butylperoxy)hexane, Lupersol™ 101 from Atofina (Paris, France). The primary co-agent was styrene and used as received from Fisher Scientific (Fairlawn, N.J.). The secondary co-agent was trimethylolpropane triacrylate (TMPTA) and used as received from Sartomer (Exton, Pa.). The polypropylene compositions were processed using an APV® co-rotating reactive twin screw extruder supplied by B&P Process Systems (Saginaw, Mich.) employing a temperature gradient from 160° C. in the feed zone to 210° C. at the die and a screw speed of 150 rpm. The radical initiator and the co-agents were mixed by magnetically stirring for 5 minutes to yield a homogeneous liquid mixture. A small portion of the liquid mixture was used to wet a mixture of the isotactic polypropylene pellets and the impact modifying polymer pellets. The wet pellets were fed into the feed zone of the extruder via an AccuRate (Whitewater, Wis.) hopper. The remaining liquid mixture was added using a metered Zenith (Sanford, N.C.) pump at the feed zone and at several ports along the extruder barrel. The polypropylene compositions exited the extruder through a strand die, quenched in a water bath, pelletized and dried in a vacuum oven at 100° C. for 24 hours.

### Example 1

The following components and their weight percent used to prepare a polypropylene composition labeled “EQ1” were: 74.3 wt. % blowmolding grade isotactic polypropylene from Equistar (Houston, Tex.), 18.6 wt % ENGAGE® 8407, 0.3 wt % Lupersol™ 101, 6.0 wt % styrene, 0.8 wt % trimethylolpropane triacrylate.

The Melt Flow Indexes were measured using ASTM D1238 for the EQ1 composition, the isotactic polypropylene used, and a blend from the isotactic polypropylene and the impact modifying polymer extruded without the radical intiator or co-agents. As may be seen in Table 1, the EQ1 composition of the present invention had melt flow index comparable to the isotactic polypropylene, but a much lower index than the blend lacking the radical initiator and co-agents.

TABLE 1

| | |
|---|---|
| Equistar isotactic polypropylene | 0.9 g/10 min |
| 80 wt % Equistar polypropylene and 20 wt % | 2.7 g/10 min |
| ENGAGE ® 8407 | |
| EQ1 | 1.1 g/10 min |

### Example 2

The following components and their weight percent used to prepare a polypropylene composition labeled “HT1” were: 74 wt. % injection molding grade isotactic polypropylene from Huntsman (Salt Lake City, Utah), 18.5 wt % ENGAGE® 8407, 0.3 wt % Lupersol™ 101, 6.0 wt % styrene, 1.2 wt % trimethylolpropane triacrylate. Huntsman isotactic polypropylene displayed a melt flow index of 5.

The Notched Izod Impact at Room Temperature was tested using the method ASTM D256 on samples of HT1, EQ1 of Example 1, the equivalent blends extruded without the radical initiator and co-agents of HT1 and EQ1, and the isotactic polypropylenes used to prepare HT1 and EQ1. As may be seen by the results set forth in Table 2, the compositions of the present invention had markedly improved impact strengths as compared to isotactic polypropylene and the isotactic polypropylene impact modifying polymer blends absent the radical imitator and co-agents.

TABLE 2

| | |
|---|---|
| Equistar isotactic polypropylene | 0.99 ft-lbs/in |
| 80 wt % Equistar polypropylene and 20 wt % | 6.7 ft-lbs/in |
| ENGAGE ® 8407 | |
| EQ1 | 13.4 ft-lbs/in |
| Huntsman isotactic polypropylene | 0.55 ft-lbs/in |
| 80 wt % Huntsman polypropylene and 20 wt % | 1.3 ft-lbs/in |
| ENGAGE ® 8407 | |
| HT1 | 3.4 ft-lbs/in |

It is to be understood that while the invention has been described in conjunction with the preferred specific embodiments thereof, that the foregoing description as well as the examples, which followed are intended to illustrate and not limit the scope of the invention. Other aspects, advantages and modifications within the scope of the invention will be apparent to those skilled in the art to which the invention pertains. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

We claim:

1. A method to prepare a polypropylene composition with enhancing impact strength properties comprising the steps of:
providing reaction components comprising
an isotactic polypropylene,
at least one impact modifying polymer,
at least one primary co-agent comprising a monovinyl monomer capable of undergoing vinyl addition by a radical,
at least one secondary co-agent comprising a multifunctional monomer, oligomer or polymer containing a plurality of unsaturated groups capable of undergoing radical addition, and
at least one radical initiator;
mixing said reaction components;
melting the reaction components; and
extruding the mixture to form said polypropylene composition.

2. The method of claim 1, wherein said impact modifying polymer comprises an elastomer.

3. The method of claim 2, wherein said elastomer comprises a copolymer of ethylene and an alpha-olefin.

4. The method of claim 1, wherein said monovinyl monomer is selected from the group consisting of styrene, alpha-methylstyrene, para-chlorostyrene, methyl acrylate, methyl methacrylate, ethyl acrylate, isopropyl methacrylate, n-hexyl acrylate, stearyl acrylate, vinyl acetate and a vinyltrialkysilane.

5. The method of claim 1, wherein said multifunctional monomer, oligomer or polymer is selected from the group consisting of divinyl benzene, 1,2 polybutadiene, triallylisocyanurate, diallyl terepthalate, allyl acrylate, glycerol diacrylate, glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis[1-(2acryloxy)]-p-ethoxyphenyldimethylmethane, bis[1-(3-acryloxy-2-hydroxy)]-p-propoxyphenyldimethylmethane, trishydroxyethyl-isocyanurate trimethacrylate; bisacrylates of polyethylene glycols of molecular weight 200-500, bis-methacrylates of polyethylene glycols of molecular weight 200-500, copolymerizable mixtures of acrylated monomers, and acrylated oligomers.

6. The method of claim 1, wherein said initiator comprises an organoperoxide.

7. The method of claim 6, wherein said organoperoxide is selected from the group consisiting of α,α′-bis(t-butylperoxy)-diisopropylbenzene, 2,5-dimethyl-2,5-di(t-butylperoxy)hexane, 2,5-dimethyl-2,5-di(t-butylperoxy)hexyne-3, t-amyl peroxy-2-ethylhexonate, di-t-butylperoxide, di-(t-amyl)butylperoxide, 2,5-di(t-amyl peroxy)-2,5-dimethylhexane, 2,5-di(t-butylperoxy)-2,5-diphenylhexane, bis(alpha-methylbenzyl)peroxide, benzoyl peroxide, t-butyl perbenzoate, 3,6,9-triethyl-3,6,9-trimethyl-1,4,7 triperoxonane and bis(t-butylperoxy)-diisopropylbenzene.

8. The method of claim 1, wherein mixing of some or all of said reaction components is carried out prior to introduction to an extruder or wherein mixing occurs in said extruder by introducing the reaction components to the same or different sites of said extruder wherein the sites are a hopper or one or more ports along said extruder.

9. The method of claim 1, wherein the steps of melting and extruding are carried out using a reactive twin-screw extruder.

10. A polypropylene composition comprising:
an isotactic polypropylene;
at least one impact modifying polymer dispersed in said polypropylene; and
branches on and bridges between said polymers comprising repeating units from at least one primary co-agent and at least one secondary co-agents, and residuals from at least one radical initiator.

11. The composition of claim 10, wherein said impact modifying polymer comprises an elastomer.

12. The composition of claim 11, wherein said elastomer comprises a copolymer of ethylene and an alpha-olefin.

13. The composition of claim 10, wherein said primary co-agent comprises a monovinyl monomer capable of being polymerized radically.

14. The composition of claim 13, wherein said monovinyl monomer is selected from the group consisting of styrene, alpha-methylstyrene, para-chlorostyrene, methyl acrylate, methyl methacrylate, ethyl acrylate, isopropyl methacrylate, n-hexyl acrylate, stearyl acrylate, vinyl acetate and vinytriorganosilane.

15. The composition of claim 10, wherein said secondary co-agent is a multifunctional monomer, oligomer or polymer containing a plurality of unsaturated groups capable of undergoing radical addition.

16. The composition of claim 15, wherein said multifunctional monomer, oligomer or polymer is selected from the group consisting of divinyl benzene, 1,2 polybutadiene, triallylisocyanurate, diallyl terepthalate, allyl acrylate, glycerol diacrylate, glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis[1-(2acryloxy)]-p-ethoxyphenyldimethylmethane, bis[1-(3-acryloxy-2-hydroxy)]-p-propoxyphenyldimethylmethane, trishydroxyethyl-isocyanurate trimethacrylate; bisacrylates of polyethylene glycols of molecular weight 200-500, bis-methacrylates of polyethylene glycols of molecular weight 200-500, copolymerizable mixtures of acrylated monomers, and acrylated oligomers.

17. The composition of claim 10, wherein said initiator is an organoperoxide.

18. The composition of claim 17, wherein said organoperoxide is selected from the group consisiting of α,α′-bis(t-butylperoxy)-diisopropylbenzene, 2,5-dimethyl-2,5-di(t-butylperoxy)hexane, 2,5-dimethyl-2,5-di(t-butylperoxy)hexyne-3, t-amyl peroxy-2-ethylhexonate, di-t-butylperoxide, di-(t-amyl)butylperoxide, 2,5-di(t-amyl peroxy)-2,5-dimethylhexane, 2,5-di(t-butylperoxy)-2,5-diphenylhexane, bis(alpha-methylbenzyl)peroxide, benzoyl peroxide, t-butyl perbenzoate, 3,6,9-triethyl-3,6,9-trimethyl-1,4,7 triperoxonane and bis(t-butylperoxy)-diisopropylbenzene.

19. The composition of claim 10, further comprising at least one component selected from the group consisting of process oils, plasticizers, specialty additives, fillers, and pigments.
